(19) United States
(12) Patent Application Publication
(10) Pub. No.: US 2025/0252322 A1
(43) Pub. Date: Aug. 7, 2025

(54) Constructing Structured Knowledge Bases Using Unstructured Documents

(71) Applicant: International Business Machines Corporation, Armonk, NY (US)

(72) Inventors: ZHI QIANG KOU, Beijing (CN); Bai Xin Jiang, Beijing (CN); Xiao Lei Jia, Beijing (CN); Chen Li, Dezhou (CN); Chan Gao, Beijing (CN); Min Kang Zhang, Beijing (CN)

(21) Appl. No.: 18/433,565

(22) Filed: Feb. 6, 2024

(51) Int. Cl. G06N 5/022; G06F 16/93

(52) U.S. Cl. CPC G06N 5/022; G06F 16/93

(57) ABSTRACT

Mechanisms are provided for extracting a structure from an unstructured electronic document. An unstructured electronic document is converted into a plain text document, and candidate structure identification rules are executed on the plain text document to identify candidate structural elements. Candidate structural element semantic consistency rules are executed on the candidate structural elements to remove candidate structural elements that do not match expected semantic ordering of structural elements and generate a first group of structural elements. A plurality of second groupings of candidate structural elements are generated based on the first grouping, where each second grouping comprises a different combination of structural elements than other second groupings. Candidate structural elements of the second groupings are merged to generate a hierarchical structure for the unstructured electronic document. A structured electronic document is generated, corresponding to the unstructured electronic document, based on the hierarchical structure.

### BACKGROUND

The present application relates generally to an improved data processing apparatus and method and more specifically to an improved computing tool and improved computing tool operations/functionality for constructing structured knowledge bases using unstructured documents.

Artificial Intelligence (AI) computer models have been developed for various applications. As these AI computer models have been developed over time, there is now a large range of AI computer models that organizations and users can use to process input data and generate results. This range of AI computer models ranges from relative non-complex AI models such as rules based engines, to moderately complex AI models such as shallow classifiers, convolutional neural networks (CNNs), and the like, to high complexity AI models, such as deep learning neural networks (DNNs), large language models (LLMs), and the like, which are trained on massive amounts of data to perform highly complex operations handling large diversities in input data.

AI computer models are only as good as the data that is used to train the AI computer model and the data that the AI computer model is able to use to generate predictions or classifications. Thus, data curation both during training and during runtime operation is an important aspect of improving the functionality of AI computer models.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for extracting a structure from an unstructured electronic document. The method comprises executing a data preparation operation to convert the unstructured electronic document into a plain text document, and executing candidate structure identification rules on the plain text document to identify candidate structural elements. The method further comprises executing candidate structural element semantic consistency rules on the candidate structural elements to remove candidate structural elements that do not match expected semantic ordering of structural elements, to thereby generate a first group of structural elements. The method also comprises generating a plurality of second groupings of candidate structural elements based on the first grouping of structural elements. Each second grouping comprises a different combination of structural elements than other second groupings in the plurality of second groupings. The method further comprises merging the candidate structural elements of the second groupings to generate a hierarchical structure for the unstructured electronic document, and generating a structured electronic document, corresponding to the unstructured electronic document, based on the hierarchical structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of the primary operational components of an electronic document structural hierarchy extraction system in accordance with one illustrative embodiment;

FIG. 3 is an example diagram illustrating a conversion of an electronic document to a plain text representation in accordance with one illustrative embodiment;

FIG. 4 is a first example of a chapter candidate hierarchy that shows chapter candidates that do not match an expected hierarchy and are filtered out in accordance with one illustrative embodiment;

FIG. 5 is a second example of a chapter candidate hierarchy that shows valid chapter candidates which may be further evaluated to select between multiple valid chapter candidates in accordance with one illustrative embodiment;

FIG. 6 is an example diagram of two chapter hierarchy combination possibilities for an electronic document which may be the subject of a merge operation in accordance with one illustrative embodiment;

FIG. 7 is an example diagram illustrating a chapter hierarchy after merging in which confidences in the chapter candidates are calculated in accordance with one illustrative embodiment; and

FIG. 8 is a flowchart outlining an example operation for building a knowledge base using structured data generated by extracting structure hierarchy information from unstructured electronic documents in accordance with one illustrative embodiment.

### DETAILED DESCRIPTION

The illustrative embodiments provide an improved computing tool and improved computing tool operations/functionality for generating structured knowledge bases from unstructured documents. Moreover, the structured knowledge bases generated by the mechanisms of the illustrative embodiments may then be the basis for artificial intelligence computer model operations, with the structured knowledge bases providing a more informative set of data structures for performing operations of the artificial intelligence computer models, leading to better predictions, classifications, or other results generated by the artificial intelligence computer models.

With the rapid development of artificial intelligence (AI), which operate on knowledge bases, more and more electronic documents need to be used to build knowledge bases upon which these AI computer models operate. For example, foundation models, such as large language models (LLMs) and the like, e.g., ChatGPT™, available from OpenAI OPCO, LLC, and the like, take in vast amounts of data from various sources connected to the Internet, as a knowledge base for performing their operations. However, if an electronic document, e.g., a Portable Document Format (PDF) document, is unstructured, e.g., there are no clear structural demarcations, bookmarks, or the like, defined in the document that describe the organization of the electronic document, ingesting such unstructured documents becomes difficult for the natural language processing (NLP) mechanisms of the AI computer model.

When using text information from such an unstructured document, normally the text characters are read as blocks of text, such as at a granularity of pages or lines. If the reading is performed at the page granularity, content in the same page might not focus on the same topic, which will reduce accuracy of the knowledge base built on top of the read text. Moreover, sometimes one topic crosses multiple pages of content and thus, processing the document on a page granularity may not accurately capture the fact that the text of one page is directed to the same topic as the text of another page when building a knowledge base for AI computer model operations. In addition, text content of one page is generally too long for most existing foundation models (e.g., LLMs), which have a token limit due to their resource limitations.

If the text is read at a line granularity, one line might not cover all context information inside it for a particular topic. Moreover, there is no hierarchy relationship between lines, which will reduce accuracy of the knowledge base built on top of the text.

Therefore, there is a need to extract a hierarchy structure from an unstructured document, e.g., a chapter hierarchy from such a document, to assist in the creation of the knowledge base for AI computer model operations. The illustrative embodiments provide an improved computing tool and improved computing tool operations/functionality to extract such a structure hierarchy from unstructured electronic documents when building a knowledge base for AI computer models. While the illustrative embodiments will be described using the example of a chapter hierarchy, the illustrative embodiments are not limited to such and any structural hierarchy of unstructured electronic document content may be extracted without departing from the spirit and scope of the present invention.

In accordance with one or more illustrative embodiments, a primary operation or functionality of the improved computing tool covers data preparation, candidate scanning, analyzing, rating and merging, as will be described hereafter in more detail. With regard to data preparation, the illustrative embodiments generate a plain text version of the original document. The illustrative embodiments then scan the plain text line-by-line to identify patterns of textual content that are indicative of structural transitions as well as semantically identify portions of the plain text that are likely directed to the same or similar topics, e.g., in some illustrative embodiments, chapters and sub-chapters within the plain text are identified. In some illustrative embodiments, this may be performed using a rules based engine for candidate identification, while in other illustrative embodiments a machine learning or AI computer model is trained to identify such patterns and associate with them chapters and sub-chapters.

The illustrative embodiments also analyze the candidates to ensure that they make semantic sense based on expectations of hierarchical structures of candidates, e.g., chapters and sub-chapters. This analysis may likewise utilize a rules-based engine or a machine learning trained AI computer model to evaluate the structure of the chapters and sub-chapters to remove hierarchies that are likely erroneous from a semantic and expected hierarchy point of view.

The remaining candidates are then used to generate one or more combinations of candidates by evaluating all possible combinations of candidates. That is, in cases where the hierarchical structure may be different depending on which candidates are maintained, different combinations of candidates may be generated. Thereafter, a pairwise merging of combinations is performed using merging rules so as to generate a single combination of candidates. The resulting combination of candidates then represents the extracted structural hierarchy which is used to augment the original document and/or plain text version of the original document. In this way, the original unstructured document may be converted to a structured document and included in a knowledge base for use in performing AI operations.

It should be appreciated that, for many rich-text file formats, such as PDF, if the electronic document (or simply “document” hereafter) has no structural demarcations provided, e.g., chapters and/or sub-chapters, in the electronic document itself, where a chapter or sub-chapter is a logical hierarchy of the section/content of the document. While PDFs may have bookmarks, these bookmarks are merely tools for quickly moving to a particular location within a document and are not actually specifically identifying a logical hierarchy of the document.

For example, there is no chapter information, or other structural demarcation information, that can be read directly from the rich-text formatted document. To determine a structural hierarchy, e.g., chapter hierarchy, the document needs to be converted into plain text, if it is not already in plain text format, and then understand the content of the document represented in the plain text from a semantic perspective. However, before converting the document to plain text, noise data of the document, such as page headers, page footers, author information, page numbers, and other data of the document that are not directed specifically to the topics/subjects of the content, needs to be removed, as keeping it may negatively affect the determination of the structure hierarchy of the document and should not be included any chapter representations. Such noise data may be inadvertently mixed up with page content once the document is converted into plain text, which will be much difficult to identify and ignore when extracting structural hierarchies. Therefore, this noise data should be removed before converting the document into plain text.

In some illustrative embodiments, this operation involves first splitting the document into predetermined blocks of content, e.g., pages of the document. In each block, e.g., page, noise data is identified by a trained machine learning computer model, or AI computer model, trained to identify portions of documents that are indicative of noise data. This noise data is identified, tagged, and then ignored when converting the page of the document into plain text. Once the noise data is removed from the pages and the pages are converted to plain text, the pages of plain text are merged into a single data structure, i.e., a single plain text document. In merging the pages into a single data structure, the page number for each line of plain text is maintained such that it may be later used for data provenance.

The plain text document generated by the above noise removal and conversion, is then analyzed line-by-line, to identify candidate chapters. In analyzing each line, a rule-based pattern analysis engine is used to apply predefined computer executed rules to identify patterns of textual content that are indicative of chapter demarcations in the plain text. In some illustrative embodiments, a machine learning computer model may also or alternatively be used to identify such candidate chapters, where the computer model is trained through machine learning processes to recognize patterns of textual content associated with chapter demarcations.

Assuming a rules-based pattern analysis engine, however, one defines a group of patterns for each different level of chapters in electronic documents. For example, chapter levels may be defined as 1, 1.1, 1.2, . . . , 1.1.1, 1.1.2, . . . 1.1.1.1, etc., in a hierarchical manner, and corresponding rules specifying patterns of text are applied to the plain text to identify portions of the plain text that match the patterns in the rules, where a match indicates a location for a candidate chapter at the corresponding chapter hierarchy level. The following is an example of one possible set of rules for performing such rules-based pattern analysis:

{
// level-1 pattern, match: 1
“regex”: “\hat{ }((\d+))(?![\.\d)])”,
   },
   {
// level-2 pattern, match: 1.1
“regex”: “\hat{ }(\d+)\*\.\*(\d+)(?![\.\d])”,
   },
   {
// level-3 pattern, match: 1.1.1
“regex”: “\hat{ }(\d+)\*\.\*(\d+)\*\.\*(\d+)(?![\.\d])”,
   }

In this example set of rules, rules are associated with each of 3 levels of the chapter/sub-chapter hierarchy, e.g., 1, 1.1, and 1.1.1. The “regex” field defines the regular expression of the rule of the particular level. It should be appreciated that these are simplified rules for illustration purposes and actual rules may be much more complex with many additional or alternative fields being defined. Moreover, many different rules may be defined for each of the different hierarchical levels for chapters and sub-chapters, and there may be many more levels of hierarchy beyond the example of 3 levels.

As a result of the rules-based analysis, chapter candidates are identified in the plain text, with the chapter candidates having corresponding hierarchical chapter designations. Thus, for example, the chapter level 1 may be a highest level of the hierarchy, with lower levels being 1.1, 1.2, etc. with levels having the same position of dependency from the higher level being considered at a same chapter hierarchy level, e.g., 1.1 and 1.2 are at the same hierarchical level while 1.1.1 is a lower level than 1.2. It should be appreciated that some noise data, e.g., page numbers, could be recognized as chapter candidates incorrectly. This is why such noise data is filtered out or ignored before converting the electronic document into plain text, e.g., page number 9 could be recognized as candidate of chapter 9.

Once the chapter candidates are identified, an analysis is performed to match recognized chapter candidates from a semantic perspective. For example, an analysis may be performed to identify anomalies in the chapter candidates, i.e., chapter candidates that do not follow an expected hierarchy of chapters in the document given the location of the chapter candidates within the plain text. For example, if the chapter 1.1 is found as a candidate chapter in the plain text, then the next expected chapter could be: 1.1.1, 1.2, or 2. If other chapter candidates are found before these above expected chapters, e.g., a chapter 5, the chapter candidates that do not match the expected hierarchy are filtered out or ignored.

After matching chapter candidates from a semantic perspective, there still may be some noise data that could not be ignored. That is, these chapter candidates and corresponding portions of the plain text appear to provide valid chapters from a semantic perspective, e.g., chapters 2 and 3 occur after chapter 1.1.1., but before chapter 1.1.2, these may be valid chapter candidates, as chapter 1.1.2 may be incorrect. Hence, a further analysis is performed, based on a depth-first searching algorithm, to match all possible chapters recursively. The gains achieved or lost by maintaining different valid chapter candidates may be evaluated to determine which ones to keep and which ones to discard. For example, in a particular document having chapter candidates [1, 1.1., 1.1.1, 2, 3, 1.1.2, 1.2, 2], if the first chapter 2 is maintained, the identified hierarchy may be [1, 1.1, 1.1.1, 2, 3] as the later chapters 1.1.2, 1.2, and 2 would not follow the hierarchy. However, if the first chapter 2 is ignored in the hierarchy, then the hierarchy may be [1, 1.1, 1.1.1, 1.1.2, 1.2, 2]. As this second option maintains more chapter candidates than the first option, the second option may be selected and thus, the first chapter 2 candidate and the chapter 3 candidate may be eliminated from further consideration.

In order to determine which combinations of chapter candidates to maintain, after all possible chapter candidate combinations are identified, each chapter candidate combination is rated. The rating, in some illustrative embodiments, may include 3 rating factors including a count of all chapters (C), the count of sub chapters (SC), where sub chapters are the chapters which have parent chapters in the hierarchy of candidate chapters, and the count of leaf chapters (LC), where a leaf chapter is a chapter candidate that does not have any sub chapters below it in the hierarchy. It can be appreciated that with larger values of C, more chapters are recognized in the plain text. With regard to SC, as an example, a sub chapter 1.3.1 is a sub chapter of chapter 1.3, which is a sub chapter of chapter 1. On the other hand, chapter 1 has no parent and therefore, is not a sub chapter. Moreover, if chapter 1.3.1 does not have any chapters below it in the hierarchy, it may also be a leaf chapter.

Noise data may appear in random locations in the hierarchy. The less noise data present in the plain text and thus, represented in the chapter candidates, the greater the values of C, SC, and LC will be. For complex documents, the process of identifying chapter candidates and then combinations of these chapter candidates may result in many tens, hundreds or thousands of combinations being recognized, which cannot be practically considered through manual processes. The illustrative embodiments provide mechanisms for selecting a predetermined number of combinations with the highest C, SC and LC for further processing.

After rating the combinations of candidate chapters, the predetermined number of combinations with the highest C, SC and LC are selected for merging. Each combination of chapter candidates is a tree-like data structure, with each chapter candidate being a node in the tree-like data structure and edges connecting the chapter nodes in accordance with chapter hierarchy rules. Each chapter node on the tree has a counter associated with it that maintains a count of how many times that chapter node is merged with another chapter node. The illustrative embodiments process pairs of these combinations of candidate chapters for determining whether to merge chapter candidates of the combinations or not when merging the combinations into a single combination of candidate chapters. The determination of whether to merge chapters may be performed by applying merging rules to the combinations, where these merging rules look at patterns of hierarchies of chapter candidates, with the merging rules triggering when patterns in the combinations match the patterns specified in the merging rules. When the merging rules are triggered, merging operations are performed to combine chapters and sub-chapters as appropriate for representing a single combination of chapter candidates. This is done recursively with each pairing of combinations.

For example, in some illustrative embodiments, in order to determine whether to merge two chapter candidates of two different possible combinations of chapter candidates, i.e., a first combination referred to as the “left” combination and a second combination referred to as the “right” combination, merging rules may be executed to evaluate whether to merge the chapter candidates. For example, if two chapter candidates, of two different possible combinations “right” and “left”, have the same line number, the same hierarchy level, and the same chapter number, they are merged and treated as identical. That is, the “left” data structure may be maintained, and the counter of the chapter node is increased by 1. For example, for chapter 1, if the two sub-trees of chapter 1 in the “left” data structure and “right” data structure, have the same parent chapter (chapter 1) and the same sub chapters (1.1., 1.2, etc.), they will be treated as identical and merged. Thus, the data structure on the left side will be kept, and the counter of the parent chapter (chapter 1) and all sub chapters (e.g., 1.1, 1.2, etc.) on the sub-tree will be increased by 1.

If the two chapter candidates are determined to not be identical in the manner mentioned above, a combination that maintains the highest number of chapters, sub-chapters, and leaf chapters is selected, and the counter for that chapter candidate is not increased. The combination data structure that was not selected is merged to the parent chapter of the selected combination, e.g., sub chapter candidates that appear in the unselected combination but do not appear in the selected combination may be merged to be sub chapters of the chapter in the selected combination. That is, a large number of potential combinations are generated, each having a number of chapters, sub-chapters, and leaf chapters computed for each combination. Only the combinations with the highest values for the number of chapters, sub-chapters, and leaf chapters are selected, e.g., a predetermined number of the highest combinations are selected. Then, during the merging operation, all selected combinations are subjected to the merge operation in a pairwise manner, e.g., if 3 combinations are selected, during the merge operation, the operation first selects #1 as left side, #2 as right side, and the operation merges #2 into #1 to obtain the new #1+2 as a new left side, and then #3 is the right side which is then merged with the left side to obtain a final solution of combinations #1+2+3 as the final solution.

After such merging, a single tree-like data structure is generated where each chapter node has a counter that specifies how many times it was merged during the combination merging process. A confidence of each chapter candidate may be determined based on a function of the counter values for the chapter candidate. Moreover, counter values for sub chapters may also be used in this function in some illustrative embodiments, to determine a confidence in the chapter candidate. For example, in one illustrative embodiment, the counter values for the counters are divided by the total number of the merged combinations in order to calculate a confidence value or score for each of the chapter candidates in the single merged combination.

Finally, one chapter hierarchy data structure is generated, with each recognized chapter candidate and its sub chapters, along with the confidence value or score for each chapter candidate. The chapter candidates which have a confidence value or score lower than a predetermined threshold confidence value/score may be presented to a user for verification and selection of which chapter candidates to keep and which to discard. If a chapter candidate is identified for discarding, i.e., as a non-chapter, by user, the illustrative embodiments may repeated the above operations to generate a new merged combination in response to the removal or discarding of this non-chapter. In this way, the user can take part in the procedure as a supervisor to the chapter hierarchy data structure generation. This procedure can be repeated until the user is satisfied with the resulting chapter hierarchy.

It should be appreciated that, in other illustrative embodiments, automated processes may operate on the confidence values or scores generated for the chapter candidates in order to generate a resulting chapter hierarchy. For example, an analysis of the confidence values/scores for chapter candidates, related sub-chapter candidates, and the like, may be performed to determine whether to maintain or remove the chapter candidates and/or sub-chapter candidates. For example, if a chapter confidence value/score is equal to or above the threshold value/score, and a sub-chapter confidence is below the threshold value/score, the sub-chapter may be removed or discarded. If both the chapter candidate and sub-chapter candidate are below the threshold, then both may be discarded. There may be different evaluations performed based on these confidence values/scores depending on the desired implementation.

The plain text document is combined with the line-by-line metadata of the plain text document, e.g., total number of lines (L) of text, the particular line number of the line on a page (N), and the page number (P), which is then output to the knowledge base. The knowledge base, with the structured versions of the unstructured documents, may then be ingested by AI computer model(s) in downstream processes to perform AI computer model operations, such as classification, prediction, natural language processing and question answering, performing interactive conversation bot operations, etc. In this way, the knowledge base with the structured documents can be used to build AI powered applications, such as Question Answering (QA) assistants, or used to calculate semantic similarity between documents, which may serve as a basis for more complex AI operations.

Thus, with the mechanisms of the illustrative embodiments, an unstructured electronic document, e.g., a plaintext document, is converted to a structured data structure where structural sections, e.g., chapters and sub-chapters, are organized as hierarchy levels. The chapter hierarchy makes it possible to combine context-related information together when building the knowledge base. Since the context-related information is combined together in the knowledge base, when executing AI operations on the knowledge base, such as when executing a semantic similarity query, more accurate result will be output.

For example, to perform a semantic similarity search, a similarity calculation, such as cosine similarity, is performed between two text vectors. Before making this calculation, however, the texts are transformed to vectors for performing this similarity calculation, which leverages technologies such as word embedding or sentence embedding. Usually, humans organize related content into chapters when authoring documents. For example, assume that there is a document describing a shopping mall that has two chapters: Chapter 1: Food: On 3rd floor there is pizza, Sushi and bacon . . . , Chapter 2: Clothes: On 2nd floor there is Canada Goose, UNIQLO . . . , etc. If a search input is “I am hungry, I am about to have some food”. In vector space, the search input is closer (more similar) to Chapter 1 which is a “more accurate result”, because Chapter 2 is about clothes. Thus, by combining context related information together into chapters and/or sub-chapters, when performing such semantic searches, improved results are obtained than if the information were not combined into common contexts. Adding context to a piece of natural language content, e.g., text, can make its semantics more accurate, narrow the search space, and make the search more accurate. For example: the term “neural network” is found in biological sciences and computer science. If one searches for “neural networks”, multiple results may be obtained, but if the search is done adding the context of “biology” to this search, only one result is returned.

The mechanisms of the illustrative embodiments are not dependent on the style of the textual content in the unstructured electronic document, e.g., the visual organization of the electronic document. Therefore, the illustrative embodiments can operate accurately even with electronic documents where the textual style is not available, e.g., plaintext documents, or where different portions of the electronic document use the same style such that they cannot be distinguished based on stylistic differences.

The illustrative embodiments, while operating to eliminate as much noise data as possible in the original document prior to converting the original document to plain text, can still operate even in the presence of noise data that makes its way into the plain text. That is, this noise data may give rise to additional combinations of chapter candidates and each will be evaluated through the mechanisms of the illustrative embodiments. Through the analysis, rating, and merging operations, the combinations of chapter candidates that are noisy will be eliminated of significantly minimized, with potentially automated or manual supervision addressing any minimized noise that may still exist. The operation can be visually debugged by manually viewing the original document and the chapter hierarchy that is generated by the mechanisms of the illustrative embodiments. Hence, modifications and optimizations of the various rules and/or machine learning computer models may be performed based on user feedback and/or automated optimizations.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides mechanisms for extracting structural hierarchies from unstructured documents and generating structured versions of these documents for inclusion as part of a knowledge base for AI computer model operations. The improved computing tool implements mechanism and functionality, such as a document structural hierarchy extraction system, which cannot be practically performed by human beings either outside of, or with the assistance of, a technical environment, such as a mental process or the like. The improved computing tool provides a practical application of the methodology at least in that the improved computing tool is able to expand and improve the content of knowledge bases for AI computer model operations through automated conversion of unstructured documents into structured documents with explicit structure hierarchies that may be leveraged to identify additional knowledge from the document.

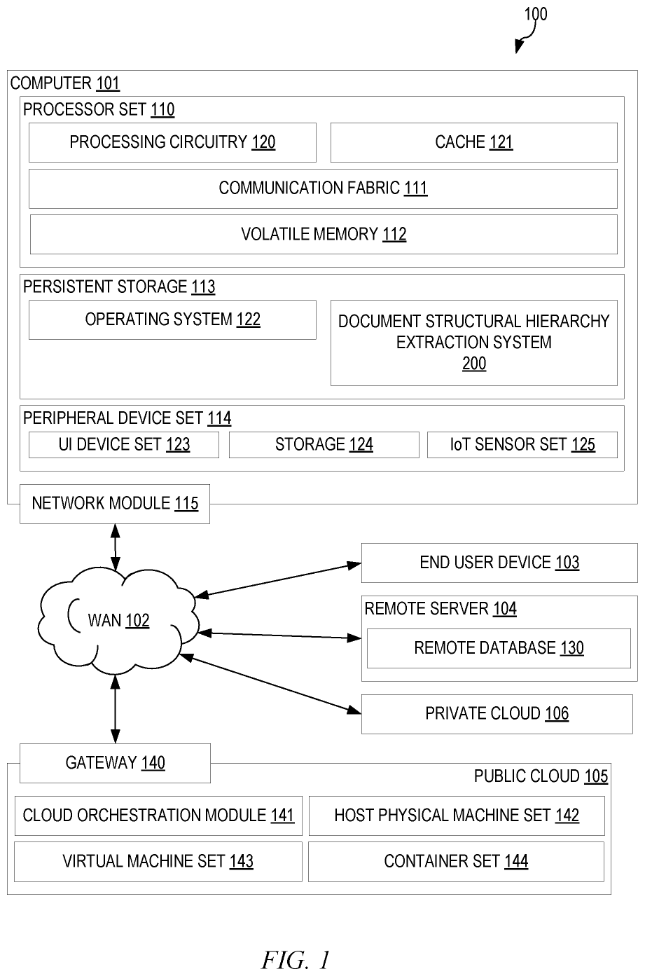

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as document structural hierarchy extraction system 200. In addition to block XZ00, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and document structural hierarchy extraction system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in document structural hierarchy extraction system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in document structural hierarchy extraction system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a document structural hierarchy extraction system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates conversion of unstructured documents to structured documents with explicit structural hierarchies that are then added to a knowledge base that is the basis for AI computer model operations. This in turn improves the operation of the AI computer model as it increases the knowledge upon which the AI computer model may operate and provide more accurate results.

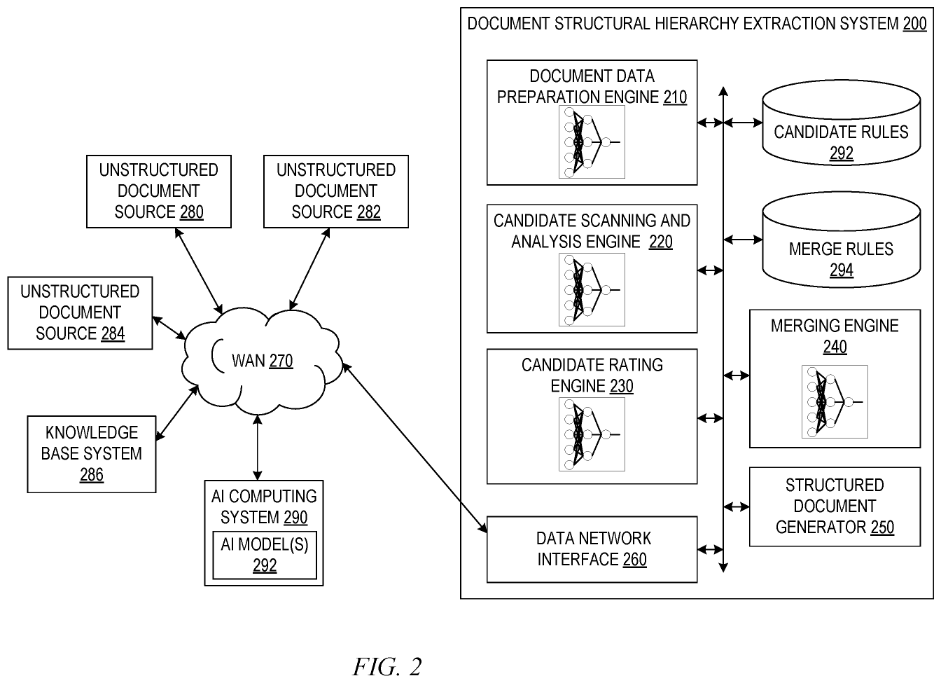

FIG. 2 is an example diagram of the primary operational components of an electronic document structural hierarchy extraction system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way knowledge bases are constructed for AI computer model operations, and specifically to automated conversion of unstructured documents to structured documents with explicit structural hierarchies, where these explicit structural hierarchies are extracted from the plain text of the document. These operations cannot be practically performed by human beings as a mental process and is not directed to organizing any human activity.

As shown in FIG. 2, the document structural hierarchy extraction system 200 may operate on unstructured electronic documents of one or more unstructured document source computing systems 280-284 via data communications facilitated by the data network, e.g., wide area network (WAN), 270. The document structural hierarchy extraction system 200 extracts the hierarchical structure of the unstructured document and adds the hierarchical structure as metadata associated with the original document and/or a plain text version of the original document. The resulting structured document may then be added to a knowledge base of a knowledge base system 286 for use with an AI computing system 290 having one or more AI computer models 292 that operate on the basis of the knowledge represented in the structured documents of the knowledge base. While these various systems are shown as separate systems in FIG. 2, it should be appreciated that one or more of these systems may be integrated with one another to provide combined operations and functionality. For example, the document structural hierarchy extraction system 200 may be integrated with the knowledge base system 286 as part of a curation engine that curates and processes unstructured documents for inclusion in the knowledge base.

As shown in FIG. 2, the document structural hierarchy extraction system 200, or simply the extraction system 200, comprises a document data preparation engine 210, a candidate scanning and analysis engine 220, a candidate rating engine 230, a mering engine 240, a structured document generation engine 250, and a data network interface 260. The candidate scanning and analysis engine 220, candidate rating engine 230, and merging engine 240 may each be implemented, for example, as one or more machine learning trained AI computer models in some illustrative embodiments. As machine learning AI computer models, these models are trained through a machine learning process based on training data, to perform their corresponding intended function. For example, the candidate scanning and analysis engine 220 is trained to take plain text input and determine whether the pattern of content in the plain text is indicative of a candidate chapter in the document, and output a corresponding candidate chapter classification output. The candidate rating engine 230 receives the candidate chapters determined by the candidate scanning and analysis engine 220 and is trained to score candidate chapters in accordance with the illustrative embodiments. The merging engine 240 receives the candidate chapters and their corresponding scores for a plurality of possible combinations of candidate chapters, such as in a pairwise manner, and is trained to determine which candidate chapters to merge between the combinations. In each case, the training data comprises the particular inputs that the particular computer model would receive, the computer model outputs a predicted result based on the training data, and the predicted result is compared to a ground truth label for the training data to determine a loss. Through the machine learning process, a function is applied based on the loss to determine a modification to operational parameters of the corresponding model. The corresponding model is updated and the process is repeated until the loss is reduced to equal to or below a threshold loss, or until a predetermined number of iterations, or epochs, have occurred, at which time the model is determined to have converged and is ready for testing and deployment.

In other illustrative embodiments, these engines 220-240 may be implemented as rules based engines by executing computer executable pre-defined rules from the rules repositories 292 and 294 and/or by executing pre-defined algorithms, such as in the case of the candidate rating engine 230 which may generate rating scores for various aspects of candidate chapters or combinations of candidate chapters in accordance with a predefined algorithm. Rules repository 292 stores candidate rules that specify patterns of textual content and formatting patterns that are indicative of candidate chapter locations within plain text. Rules repository 294 stores computer executable merging rules specifying conditions under which candidate chapters may be merged by the merging engine 240. These rules may be executed to determine if criteria of the rules are satisfied by the particular plain text content, candidate chapters, or the like, to trigger the rule, in which case a corresponding action is performed, e.g., generating a candidate chapter identifier, merging candidate chapters, or the like.

In accordance with one or more illustrative embodiments, a primary operation or functionality of the improved computing tool covers data preparation by the document data preparation engine 210, candidate scanning and analyzing by the candidate scanning and analysis engine 220, candidate rating by the candidate rating engine 230, and candidate merging by the merging engine 240, which then results in a structure for the original document. This structure may then be combined, by the structured document generator 250, with the original document and/or the plain text version of the original document generated by the system 200, in order to provide a structured document for use by a knowledge base system 286 in generating a knowledge base for other downstream AI operations, such as AI model 292 operations of the AI computing system 290.

With regard to data preparation, the document data preparation engine 210 receives an unstructured electronic document, such as a PDF or the like, from an unstructured document source 280-284, and generates a plain text version of the original document using any suitable plain text conversion algorithm. The unstructured electronic document may be editable or a scan copy, for example, where if the document is editable, the plaintext characters may be able to be read directly from the document, but for a scan copy, other mechanisms, such as optical character reading (OCR) or the like, may be used to convert the image of the text into actual plain text data.

The plain text comprises the textual content of the original document but with all the formatting removed. However, before converting the original unstructured electronic document to plain text, noise data of the document, such as page headers, page footers, author information, page numbers, and other data of the document that are not directed specifically to the topics/subjects of the content, are removed by the document data preparation engine 210 since keeping this noise data in the plain text document may negatively affect the determination of the structure hierarchy of the document. Such noise data may be inadvertently mixed up with page content once the document is converted into plain text, which will be much more difficult to identify and ignore when extracting structural hierarchies.

In some illustrative embodiments, this operation for noise removal performed by the document data preparation engine 210 involves first splitting the original unstructured document into predetermined blocks of content, e.g., pages of the document. In each block, e.g., page, the document data preparation engine 210 identifies noise data, such as by executing a trained machine learning computer model, or AI computer model, on the page content to identify portions of documents that are indicative of noise data. This noise data is identified, tagged, and then ignored when the document data preparation engine 210 converts the page of the document into plain text. Once the noise data is removed from the pages and the pages are converted to plain text, the pages of plain text are merged into a single data structure, i.e., a single plain text document. In merging the pages into a single data structure, the page number for each line of plain text is maintained such that it may be later used for data provenance.

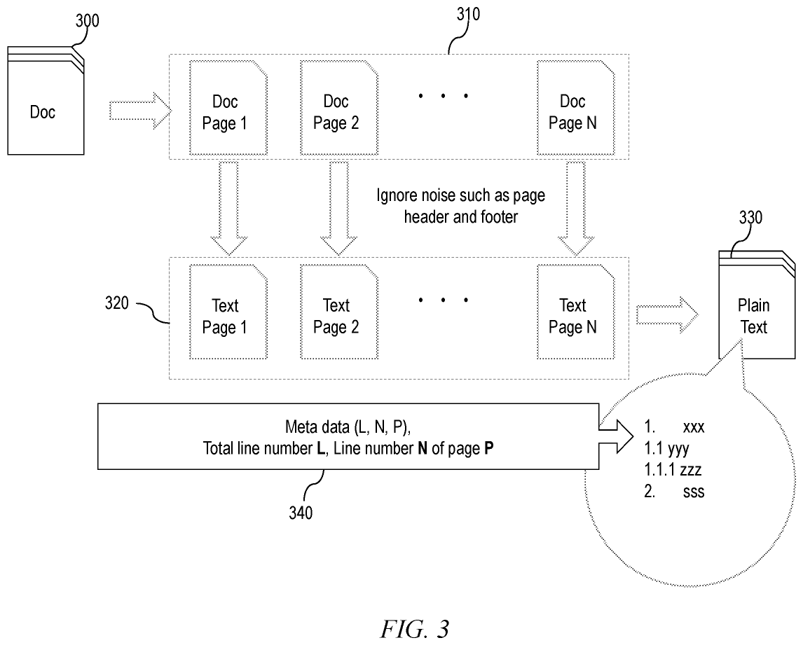

FIG. 3 is an example diagram illustrating a conversion of an electronic document to a plain text representation in accordance with one illustrative embodiment. As shown in FIG. 3, an original unstructured document 300 is first split into a plurality of document pages 310. The document data preparation engine 210 then analyzes each page to identify page noise and marks the page noise so that it may be ignored when converting the page to text pages 320. The text pages are combined into a plain text document 330. The document data preparation engine 210 further generates metadata 340 for each line of the plain text document 330. This metadata includes the total number of lines in the plain text document (L), the line number (N) of that particular line within a page (P) of the text pages 320. This metadata, being for each line in the plain text document 330 will include candidate chapter locations once the chapters are identified.

Returning to FIG. 2, the plain text document generated by the above noise removal and conversion, is then analyzed by the candidate scanning and analysis engine 220 line-by-line, to identify candidate chapters. In analyzing each line, a rule-based pattern analysis may be performed by the candidate scanning and analysis engine 220 to apply predefined computer executed rules from the candidate rules 292 repository to identify patterns of textual content in the plain text document 330 that are indicative of chapter demarcations in the plain text. In some illustrative embodiments, a machine learning computer model may also or alternatively be used to identify such candidate chapters, where the computer model is trained through machine learning processes to recognize patterns of textual content associated with chapter demarcations as noted above.

Assuming a rules-based pattern analysis engine, however, one defines a group of patterns for each different level of chapters in electronic documents. For example, chapter levels may be defined as 1, 1.1, 1.2, . . . , 1.1.1, 1.1.2, . . . 1.1.1.1, etc., in a hierarchical manner, and corresponding rules specifying patterns of text are applied to the plain text document 330 to identify portions of the plain text that match the patterns in the rules, where a match indicates a location for a candidate chapter at the corresponding chapter hierarchy level.

As a result of the rules-based analysis of the candidate scanning and analysis engine 220, chapter candidates are identified in the plain text, with the chapter candidates having corresponding hierarchical chapter designations. Thus, for example, the chapter level 1 may be a highest level of the hierarchy, with lower levels being 1.1, 1.2, etc. with levels having the same position of dependency from the higher level being considered at a same chapter hierarchy level, e.g., 1.1 and 1.2 are at the same hierarchical level while 1.1.1 is a lower level than 1.2.

Once the chapter candidates are identified by the candidate scanning and analysis engine 220, an analysis is performed to match recognized chapter candidates from a semantic perspective. For example, an analysis may be performed to identify anomalies in the chapter candidates, i.e., chapter candidates that do not follow an expected hierarchy of chapters in the document given the location of the chapter candidates within the plain text. For example, if the chapter 1.1 is found as a candidate chapter in the plain text, then the next expected chapter could be: 1.1.1, 1.2, or 2. If other chapter candidates are found before these above expected chapters, e.g., a chapter 5, the chapter candidates that do not match the expected hierarchy are filtered out or ignored.

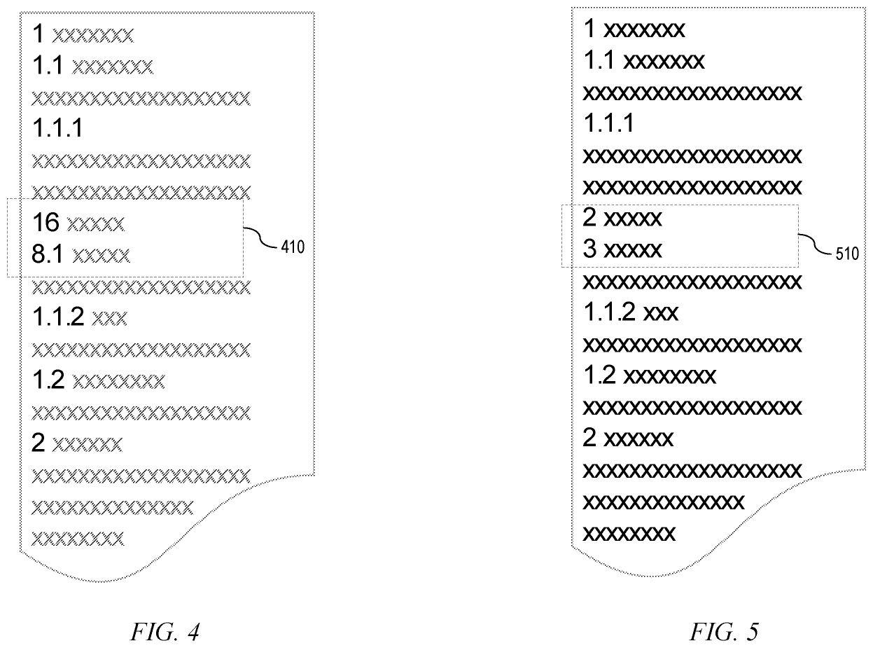

FIG. 4 is a first example of a chapter candidate hierarchy that shows chapter candidates that do not match an expected hierarchy and are filtered out in accordance with one illustrative embodiment. As shown in FIG. 4, the candidate chapters follow an expected pattern of chapters and sub-chapters from 1 to 1.1, to 1.1.1. However, thereafter, in portion 410, the candidate chapters indicate chapters 16 and 8.1. These candidate chapters may be present due to remaining noise that was not able to be filtered out through the document to plain text conversion, e.g., page numbers, numbers in header/footers, or the like. The candidate scanning and analysis engine 220 may identify these candidate chapters and then analyze the candidate chapters to identify such situations where the sequence of candidate chapters and sub-chapters does not match what is expected. For example, after sub-chapter 1.1.1, while 16 is a possibility as it is a higher number than 1 and is after chapter 1, the candidate chapter sequence 16 and then 8.1 does not match this expected pattern since 8.1 is a lower chapter/sub-chapter number than 16. Moreover, as further analysis will identify, the chapter 16 is prior to chapter 1.1.2 and thus, another anomaly would be detected as well.

FIG. 5 is a second example of a chapter candidate hierarchy that shows valid chapter candidates which may be further evaluated to select between multiple valid chapter candidates in accordance with one illustrative embodiment. As shown in FIG. 5, similar to the sequence of 16 to 1.1.2 in FIG. 4, in section 510 while each of candidate chapters 2 and 3 are valid when compared to candidate chapter sequence 1, 1.1, 1.1.1, neither is correct when one considers subsequent candidate chapter 1.1.2 as they are both higher in value than candidate chapter 1.1.2. Thus, an anomaly is again identified in this case. Hence, with FIGS. 4 and 5, the anomalies detected are candidate chapters 15, 8.1, 2, and 3.

In the examples of FIGS. 4 and 5, it can be seen that after matching chapter candidates from a semantic perspective, there still may be some noise data that could not be ignored. That is, these chapter candidates and corresponding portions of the plain text document 330 appear to provide valid chapters from a semantic perspective, e.g., chapters 2 and 3 occur after chapter 1.1.1., but before chapter 1.1.2, these may be valid chapter candidates, as chapter 1.1.2 may be incorrect. Hence, the candidate scanning and analysis engine 220 executes analysis of the candidate chapters based on a depth-first searching algorithm, to match all possible chapters recursively, where matching means to identify which candidate chapters satisfy the semantic requirements for candidate chapter sequences as specified in the logic of the candidate scanning and analysis engine 220.

The gains achieved or lost by maintaining different valid chapter candidates may be evaluated to determine which ones to keep and which ones to discard. For example, in a particular document having chapter candidates [1, 1.1., 1.1.1, 2, 3, 1.1.2, 1.2, 2], as in FIG. 5, if the first chapter 2 is maintained, the identified hierarchy may be [1, 1.1, 1.1.1, 2, 3] as the later chapters 1.1.2, 1.2, and 2 would not follow the expected sequence or chapter structure hierarchy. However, if the first chapter 2 is ignored in the hierarchy, then the hierarchy may be [1, 1.1, 1.1.1, 1.1.2, 1.2, 2]. As this second option maintains more chapter candidates than the first option, the second option may be selected and thus, the first chapter 2 candidate and the chapter 3 candidate may be eliminated from further consideration. Similarly, in the example of FIG. 4, the candidate chapters 16 and 8.1 may be removed as the removal results in more of the other chapter candidates being maintained and matching the expected structural hierarchy.

In order to determine which combinations of chapter candidates to maintain, after all possible chapter candidate combinations are identified by the candidate scanning and analysis engine 220, each chapter candidate combination is rated by the candidate raining engine 230. The rating, in some illustrative embodiments, may include 3 rating factors including a count of all chapters (C), the count of sub chapters (SC), where sub chapters are the chapters which have parent chapters in the hierarchy of candidate chapters, and the count of leaf chapters (LC), where a leaf chapter is a chapter candidate that does not have any sub chapters below it in the hierarchy. It can be appreciated that with larger values of C, more chapters are recognized in the plain text. With regard to SC, as an example, a sub chapter 1.3.1 is a sub chapter of chapter 1.3, which is a sub chapter of chapter 1. On the other hand, chapter 1 has no parent and therefore, is not a sub chapter. Moreover, if chapter 1.3.1 does not have any chapters below it in the hierarchy, it may also be a leaf chapter.

Noise data may appear in random locations in the hierarchy. The less noise data present in the plain text document, and thus, represented in the chapter candidates, the greater the values of C, SC, and LC will be. For complex documents, the process of identifying chapter candidates and then combinations of these chapter candidates may result in many tens, hundreds or thousands of combinations being recognized, which cannot be practically considered through manual processes. The illustrative embodiments provide mechanisms for selecting a predetermined number of combinations with the highest C, SC and LC for further processing.

The rating may be a function of the values of C, SC, and LC. For example, a weighted function may be utilized in which each of these values of C, SC, and LC are given corresponding weights and then the weighted values are combined to generate a rating score for the particular combination of candidate chapters. In some illustrative embodiments, higher weights may be provided to chapter (C) than sub-chapters (SC), which have higher weights than leaf chapters LC. As a result of the rating, each combination of candidate chapters will have a corresponding rating.

After rating the combinations of candidate chapters by the candidate rating engine 230, the predetermined number of combinations with the highest rating are selected for merging by the merging engine 240. Each combination of chapter candidates is a tree-like data structure, with each chapter candidate being a node in the tree-like data structure and edges connecting the chapter nodes in accordance with chapter hierarchy rules. Each chapter node on the tree has a counter associated with it that maintains a count of how many times that chapter node is merged with another chapter node. The illustrative embodiments process pairs of these combinations of candidate chapters for determining whether to merge chapter candidates of the combinations or not when merging the combinations into a single combination of candidate chapters. The determination of whether to merge chapters may be performed by applying merging rules to the combinations, where these merging rules look at patterns of hierarchies of chapter candidates, with the merging rules triggering when patterns in the combinations match the patterns specified in the merging rules. When the merging rules are triggered, merging operations are performed to combine chapters and sub-chapters as appropriate for representing a single combination of chapter candidates. This is done recursively with each pairing of combinations.

FIG. 6 is an example diagram of two chapter hierarchy combination possibilities for an electronic document which may be the subject of a merge operation in accordance with one illustrative embodiment. As shown in FIG. 6, in order to determine whether to merge two chapter candidates of two different possible combinations of chapter candidates 610 and 620, i.e., a first combination referred to as the “left” combination 610 and a second combination 620 referred to as the “right” combination, merging rules may be executed to evaluate whether to merge the chapter candidates of the two combinations 610 and 620. For example, if two chapter candidates, of two different possible combinations “right” 620 and “left” 610, have the same line number (from the metadata 340), the same hierarchy level (C, SC, LC), and the same chapter number (e.g., 1.1.1), they are merged and treated as identical. That is, the “left” data structure 610 may be maintained, and the counter of the chapter node is increased by 1. For example, for chapter 1, if the two sub-trees of chapter 1 in the “left” data structure 610 and “right” data structure 620, have the same parent chapter (chapter 1) and the same sub chapters (1.1., 1.2, etc.), they will be treated as identical and merged with corresponding counter increments. Thus, the data structure 610 on the left side will be kept, and the counter of the parent chapter (chapter 1) and all sub chapters (e.g., 1.1, 1.2, etc.) on the sub-tree will be increased by 1.

If the two chapter candidates are determined to not be identical in the manner mentioned above, a combination that maintains the highest number of chapters, sub-chapters, and leaf chapters is selected, and the counter for that chapter candidate is not increased. The combination data structure that was not selected is merged to the parent chapter of the selected combination, e.g., sub chapter candidates that appear in the unselected combination but do not appear in the selected combination may be merged to be sub chapters of the chapter in the selected combination.

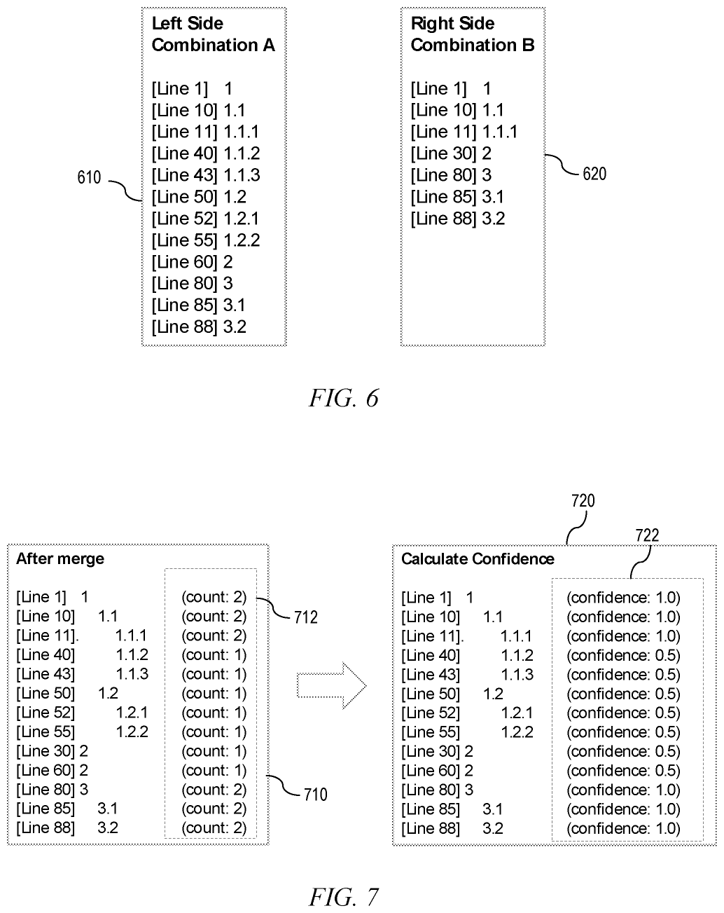

After such merging, a single tree-like data structure is generated where each chapter node has a counter that specifies how many times it was merged during the combination merging process. FIG. 7 is an example diagram illustrating a chapter hierarchy after merging in which confidences in the chapter candidates are calculated in accordance with one illustrative embodiment. As shown in FIG. 7, the resulting merged chapter candidates 710 have corresponding counter values 712 for each chapter candidate. These chapter candidate counter values 712 are used to generate confidence values for each candidate chapter indicating how confident the mechanisms are that the candidate chapter is a valid chapter in the structure of the unstructured document. The confidence values may correspond to counter values in that higher counter values result in higher confidences.

The confidence value 722 of each chapter candidate may be determined based on a function of the counter values for the chapter candidate. Moreover, counter values for sub chapters may also be used in this function in some illustrative embodiments, to determine a confidence in the chapter candidate. For example, in one illustrative embodiment, the counter values for the counters are divided by the total number of the merged combinations in order to calculate a confidence value or score for each of the chapter candidates in the single merged combination.

Finally, one chapter hierarchy data structure is generated by the structured document generator 250 based on the merged document structure 720, with each recognized chapter candidate and its sub chapters, along with the confidence value or score for each chapter candidate 722. The structured document generator 250 may present the chapter candidates which have a confidence value or score lower than a predetermined threshold confidence value/score to a user for verification and selection of which chapter candidates to keep and which to discard. If a chapter candidate is identified for discarding, i.e., as a non-chapter, by the user, the illustrative embodiments may repeated the above operations to generate a new merged combination in response to the removal or discarding of this non-chapter. In this way, the user can take part in the procedure as a supervisor to the chapter hierarchy data structure generation. This procedure can be repeated until the user is satisfied with the resulting chapter hierarchy.

It should be appreciated that, in other illustrative embodiments, automated processes of the structured document generator 250 may operate on the confidence values or scores generated for the chapter candidates in order to generate a resulting chapter hierarchy. For example, an analysis of the confidence values/scores for chapter candidates, related sub-chapter candidates, and the like, may be performed to determine whether to maintain or remove the chapter candidates and/or sub-chapter candidates. For example, if a chapter confidence value/score is equal to or above the threshold value/score, and a sub-chapter confidence is below the threshold value/score, the sub-chapter may be removed or discarded. If both the chapter candidate and sub-chapter candidate are below the threshold, then both may be discarded. There may be different evaluations performed by the structured document generator 250 based on these confidence values/scores depending on the desired implementation.

The plain text document is combined with the line-by-line metadata of the plain text document, e.g., total number of lines (L) of text, the particular line number of the line on a page (N), and the page number (P), which is then output to the knowledge base system 286. The knowledge base system 286, with the structured versions of the unstructured documents, may then be ingested by AI computer model(s) 292 of AI computer systems 290 in downstream processes to perform AI computer model operations, such as classification, prediction, natural language processing and question answering, performing interactive conversation bot operations, etc. In this way, the knowledge base of the knowledge base system 286, with the structured documents, can be used to build AI powered applications, such as Question Answering (QA) assistants, or used to calculate semantic similarity between documents, which may serve as a basis for more complex AI operations.

Thus, the illustrative embodiments provide automated computer logic to automatically convert an unstructured electronic document to a structured electronic document having a structural hierarchy, such as chapters and sub-chapters, are organized as hierarchy levels. The chapter hierarchy makes it possible to combine context-related information together when building the knowledge base. Since the context-related information is combined together in the knowledge base, when executing AI operations on the knowledge base, such as when executing a semantic similarity query, more accurate result will be output.

As noted above, the mechanisms of the illustrative embodiments are not dependent on the style of the textual content in the unstructured electronic document, e.g., the visual organization of the electronic document. Therefore, the illustrative embodiments can operate accurately even with electronic documents where the textual style is not available, e.g., plaintext documents, or where different portions of the electronic document use the same style such that they cannot be distinguished based on stylistic differences.

As discussed previously, even though the illustrative embodiments operate to remove or minimize the noise data present in the plain text in order to minimize the possibilities of erroneous candidate chapters, noise data may persist and give rise to additional combinations of chapter candidates. However, through the analysis, rating, and merging operations, the combinations of chapter candidates that are noisy will be eliminated or significantly minimized, with potentially automated or manual supervision addressing any minimized noise that may still exist. The operation can be visually debugged by manually viewing the original document and the chapter hierarchy that is generated by the mechanisms of the illustrative embodiments.

Hence, modifications and optimizations of the various rules and/or machine learning computer models may be performed based on user feedback and/or automated optimizations.

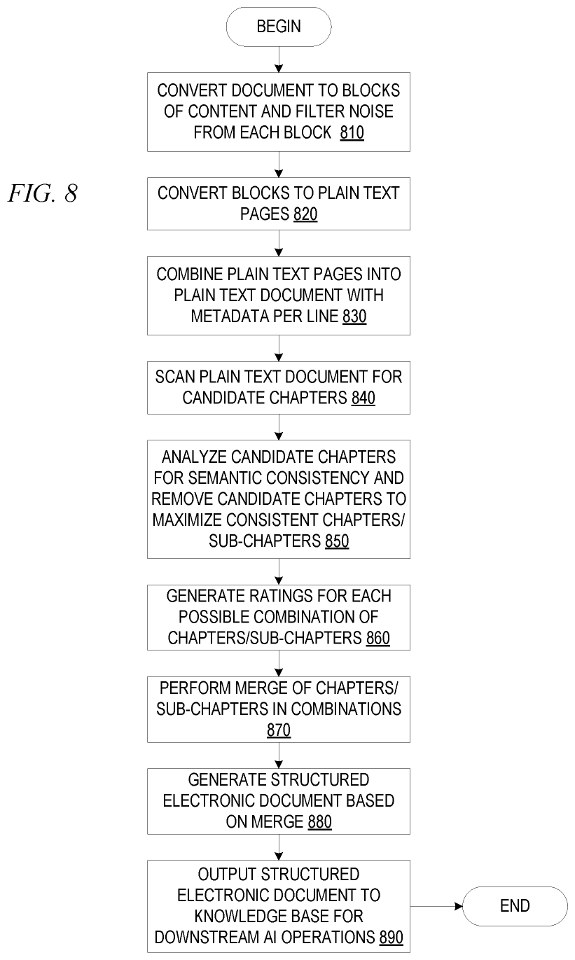

FIG. 8 is a flowchart outlining an example operation for building a knowledge base using structured data generated by extracting structure hierarchy information from unstructured electronic documents in accordance with one illustrative embodiment. It should be appreciated that the operations outlined in FIG. 8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 8, and may, in some cases, make use of the results generated as a consequence of the operations set forth in FIG. 8, the operations in FIG. 8 themselves are specifically performed by the improved computing tool in an automated manner.

As shown in FIG. 8, the operation starts by converting the unstructured document to blocks, e.g., pages, of content and noise in each block is filtered out, e.g., headers, footers, page numbers, author information, and other noise are removed (step 810). The blocks of content, with noise filtered out, are converted to plain text pages (step 820). The plain text pages are combined into a plain text document with metadata per line indicating, for example, the total number of lines in the plain text document and the current line number of the line within the identified page (step 830). The plain text document is scanned for candidate chapters (step 840) and the identified candidate chapters are analyzed for semantic consistency, with those candidate chapters not meeting consistency requirements being removed based on an evaluation to maximize consistent chapters/sub-chapters (step 850). For each possible combination of chapters/sub-chapters, a rating is generated (step 860). The combinations are then merged until a final merged combination is generated (step 870). The final merged document is then used to generate a structured electronic document having a chapter structure hierarchy (step 880). The structured electronic document is then output to the knowledge base system for use in building a knowledge base for downstream AI operations (step 890). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for extracting a structure from an unstructured electronic document, the method comprising:
executing a data preparation operation to convert the unstructured electronic document into a plain text document;
executing candidate structure identification rules on the plain text document to identify candidate structural elements;
executing candidate structural element semantic consistency rules on the candidate structural elements to remove candidate structural elements that do not match expected semantic ordering of structural elements, to thereby generate a first group of structural elements;
generating a plurality of second groupings of candidate structural elements based on the first grouping of structural elements, wherein each second grouping comprises a different combination of structural elements than other second groupings in the plurality of second groupings;
merging the candidate structural elements of the second groupings to generate a hierarchical structure for the unstructured electronic document; and
generating a structured electronic document, corresponding to the unstructured electronic document, based on the hierarchical structure.

2. The method of claim 1, wherein the candidate structural elements comprise one or more of candidate chapters or candidate sub-chapters.

3. The method of claim 2, wherein generating a plurality of second groupings of candidate structural elements based on the first grouping of structural elements, comprises generating a second grouping for each possible combination of chapters and sub-chapters in the plain text document.

4. The method of claim 3, wherein the different second groupings are different based on which chapters or sub-chapters are maintained and which chapters or sub-chapters are eliminated from the combination of chapters and sub-chapters in the plain text document.

5. The method of claim 2, wherein generating the first grouping of structural elements comprises executing candidate structural element semantic consistency rules specifying conditions of expected sequences of chapters and sub-chapters to identify one or more of chapters or sub-chapters that have invalid sequences which do not follow the expected sequences, and wherein generating a plurality of second groupings comprises identifying valid sequences of chapters and sub-chapters based on the structural element semantic rules.

6. The method of claim 5, wherein generating the first group of candidate structural elements comprises, for valid sequences that are alternative to each other, evaluating the alternative valid sequences to identify which alternative provides a maximum benefit for maintaining the alternative based on a function of a number of chapters, sub-chapters, and leaf chapters in each alternative, and wherein alternatives that do not provide a maximum benefit are not maintained in the first group of candidate structural elements.

7. The method of claim 1, wherein executing structural element identification rules comprises performing a line-by-line execution of the candidate structure identification rules on each line of the plain text document to determine whether the line comprises a pattern of content matching a pattern specified in one or more of the candidate structure identification rules.

8. The method of claim 1, wherein executing the data preparation operation comprises:
splitting the unstructured electronic document into blocks of content;
removing noise from the blocks of content to generate denoised blocks of content;
converting the denoised blocks of content to plain text pages of content; and
combining the plain text pages of content to generate the plain text document.

9. The method of claim 8, wherein:
the noise comprises at least one of page headers, page footers, author information, page numbers, or data of the block of content that is not directed specifically to topics/subjects of the content,
the blocks of content are pages of the unstructured electronic document, and
removing noise from the pages of the unstructured electronic document comprises executing a trained machine learning computer model, specifically trained to identify portions of the pages that are indicative of noise data, on the data of each page of the unstructured electronic document.

10. The method of claim 1, further comprising:
generating a knowledge base based on the structured electronic document corresponding to the unstructured electronic document; and
training a machine learning computer model based on the knowledge base.

11. A computer program product comprising a computer readable storage medium having a computer readable program stored therein, wherein the computer readable program, when executed on a computing device, causes the computing device to:
execute a data preparation operation to convert an unstructured electronic document into a plain text document;
execute candidate structure identification rules on the plain text document to identify candidate structural elements;
execute candidate structural element semantic consistency rules on the candidate structural elements to remove candidate structural elements that do not match expected semantic ordering of structural elements, to thereby generate a first group of structural elements;
generate a plurality of second groupings of candidate structural elements based on the first grouping of structural elements, wherein each second grouping comprises a different combination of structural elements than other second groupings in the plurality of second groupings;
merge the candidate structural elements of the second groupings to generate a hierarchical structure for the unstructured electronic document; and
generate a structured electronic document, corresponding to the unstructured electronic document, based on the hierarchical structure.

12. The computer program product of claim 11, wherein the candidate structural elements comprise one or more of candidate chapters or candidate sub-chapters.

13. The computer program product of claim 12, wherein generating a plurality of second groupings of candidate structural elements based on the first grouping of structural elements, comprises generating a second grouping for each possible combination of chapters and sub-chapters in the plain text document.

14. The computer program product of claim 13, wherein the different second groupings are different based on which chapters or sub-chapters are maintained and which chapters or sub-chapters are eliminated from the combination of chapters and sub-chapters in the plain text document.

15. The computer program product of claim 12, wherein generating the first grouping of structural elements comprises executing candidate structural element semantic consistency rules specifying conditions of expected sequences of chapters and sub-chapters to identify one or more of chapters or sub-chapters that have invalid sequences which do not follow the expected sequences, and wherein generating a plurality of second groupings comprises identifying valid sequences of chapters and sub-chapters based on the structural element semantic rules.

16. The computer program product of claim 15, wherein generating the first group of candidate structural elements comprises, for valid sequences that are alternative to each other, evaluating the alternative valid sequences to identify which alternative provides a maximum benefit for maintaining the alternative based on a function of a number of chapters, sub-chapters, and leaf chapters in each alternative, and wherein alternatives that do not provide a maximum benefit are not maintained in the first group of candidate structural elements.

17. The computer program product of claim 11, wherein executing structural element identification rules comprises performing a line-by-line execution of the candidate structure identification rules on each line of the plain text document to determine whether the line comprises a pattern of content matching a pattern specified in one or more of the candidate structure identification rules.

18. The computer program product of claim 11, wherein executing the data preparation operation comprises:
splitting the unstructured electronic document into blocks of content;
removing noise from the blocks of content to generate denoised blocks of content;
converting the denoised blocks of content to plain text pages of content; and
combining the plain text pages of content to generate the plain text document.

19. The computer program product of claim 18, wherein the noise comprises at least one of page headers, page footers, author information, page numbers, or data of the block of content that is not directed specifically to topics/subjects of the content.

20. An apparatus comprising:
at least one processor; and
at least one memory coupled to the at least one processor, wherein the at least one memory comprises instructions which, when executed by the at least one processor, cause the at least one processor to:
execute a data preparation operation to convert an unstructured electronic document into a plain text document;
execute candidate structure identification rules on the plain text document to identify candidate structural elements;
execute candidate structural element semantic consistency rules on the candidate structural elements to remove candidate structural elements that do not match expected semantic ordering of structural elements, to thereby generate a first group of structural elements;
generate a plurality of second groupings of candidate structural elements based on the first grouping of structural elements, wherein each second grouping comprises a different combination of structural elements than other second groupings in the plurality of second groupings;
merge the candidate structural elements of the second groupings to generate a hierarchical structure for the unstructured electronic document; and
generate a structured electronic document, corresponding to the unstructured electronic document, based on the hierarchical structure.
